(19) United States
(12) Patent Application Publication
(10) Pub. No.: US 2005/0031256 A1
(43) Pub. Date: Feb. 10, 2005

(54) Temperature compensation method of an optical wdm component and temperature-compensated optical wdm component

(76) Inventors: Thomas Paatzsch, Mainz (DE); Martin Popp, Mainz (DE); Ingo Smaglinski, Mainz (DE)

Correspondence Address: SIMPSON & SIMPSON, PLLC, 5555 MAIN STREET, WILLIAMSVILLE, NY, 14221-5406, US

(21) Appl. No.: 10/490,007

(22) PCT Filed: Aug. 7, 2002
(86) PCT No.: PCT/DE02/02891

(30) Foreign Application Priority Data
Sep. 19, 2001 (DE) 101 46 006.6

(51) Int. Cl. G02B 6/26

(52) U.S. Cl. 385/24; 385/47

(57) ABSTRACT

A temperature compensation method for an optical component using at least one cut-off or band-pass filter and beam-guiding optics is provided. An object of the invention is to provide a method with which an optical component can be operated with a temperature-dependent band pass, or cut-off filter across a wide range of temperatures. The method features orientation of the beam relative to the cut-off or band pass filter which changes subject to the temperature of the component.

### CROSS REFERENCE TO RELATED APPLICATION

This application claims priority under International Application PCT/DE02/02891, filed Aug. 7, 2002, which claims priority from German Application DE 101 46 006.6, filed Sep. 19, 2001.

The present invention relates to a method for temperature compensation of an optical WDM component with at least one band-pass filter, which has characteristics that are dependent on the temperature of the component and/or of the band-pass filter, and with beam-guiding optics, which are provided for guiding a beam through the component. Furthermore, the present invention relates to a corresponding optical WDM component.

The abbreviation WDM stands for Wavelength Division Multiplexing, i.e. simultaneous combining and transmission of optical signals of different wavelengths in a single optical fibre (generally a glass fibre) and conversely the separate coupling-out of optical signals of different wavelengths from a fibre into several separate optical fibres or components.

Especially in telecommunications and data communications, it is now customary to transmit information optically, i.e. for example via light guides. Light guides are generally thin fibres made of highly transparent optical materials, which guide light in the longitudinal direction by multiple total reflection. The electrical signals that are to be transmitted are, after appropriate modulation, converted into light signals by an electro-optical converter, coupled-in into the optical waveguide, transmitted by the optical waveguide and, at the end, converted back into electrical signals by an opto-electrical converter. To increase the transmission rate of the optical waveguides, it is now customary to transmit several different communication signals over one optical waveguide. For this purpose the communication signals are modulated. Different carrier frequencies are used in each case for the different communication signals, and the individual discrete frequency components of the complete signal transmitted are called channels. These initially separate channels are combined and fed into a single fibre (optical waveguide) prior to transmission. After the individual communication signals or wavelength channels have been transmitted over the optical waveguide, the individual signals have to be separated and demodulated.

Devices are therefore known in the industry for the adding (at the start of the common transmission line used) and the selecting (at the end of the common transmission line) of wavelength-coded signals (light of a specific wavelength or specific wavelengths), called multiplexers or demultiplexers. The purpose of these devices is to separate a corresponding wavelength channel from the plurality of channels transmitted. For this separation it is possible to use e.g. band-pass filters, especially narrow-band filters, which allow a certain frequency band of the light (usually called a “channel”) to pass almost unhindered, whereas all other frequencies are reflected.

These narrow-band filters are generally based on an optical-interference effect and are produced by alternate application of layers with high or low refractive index. In what is known as the Fabry-Perot design, a symmetrical arrangement of λ/2-layers and λ/4-layers is chosen.

However, these narrow-band filters have the property that the pass wavelength varies with the temperature of the filter. This effect is based essentially on the thermal expansion of the individual layers in the filter. Typically there is a shift in pass wavelength of the order of 1 to 3 pm/K. In the case of very narrow-band interference filters, as are generally required in telecommunications and data communications, this effect leads to a restriction of the temperature range in which the filters can be operated.

In consequence, the optical components described at the beginning, which contain such a band-pass filter with temperature-dependent characteristics, can also only be operated reliably over a limited temperature range.

Therefore the problem to be solved by the present invention is to provide a method which allows the operation of an optical component with a temperature-dependent band-pass filter (or alternatively a cut-off filter) over a wider temperature range. Another problem to be solved by the present invention is to provide a corresponding optical component, which can be operated reliably over a wide temperature range.

With respect to the method, this problem is solved in that the alignment of the light beam relative to the band-pass filter within the optical component is varied in relation to the temperature of the component.

The central pass wavelength of such a filter shifts not only on account of temperature variations and the associated changes in layer thicknesses of the individual interference layers of the band-pass filter, but for example also as a result of variation of the angle of incidence at which the light beam impinges on the filter. This is utilized by the present invention, in that a shift of the central pass wavelength towards smaller or larger wavelengths, caused by a temperature change, is at least partially compensated by an appropriate change of the alignment and primarily of the angle of incidence of the beam. In this way the temperature dependence of the central pass wavelength of the filter [on the temperature] can be reduced by appropriate alteration of the alignment of the beam relative to the band-pass filter.

Advantageously, the alignment of the beam relative to the band-pass filter is changed in such a way that the temperature-dependent shift of the pass characteristics of the band-pass filter is compensated as completely as possible.

A change in the alignment of the beam also encompasses, in the sense of the present invention, a change or shift of the point of impingement of the beam (independently of or additionally to the change in angle of incidence). This applies in particular when the pass wavelength also depends on the point of impingement of the light beam on the filter, and the filter thus has locus-dependent filter characteristics. This can for example be achieved by deliberate or even simply production-dependent variation of the thicknesses of the interference layers from the centre to the edge of a filter. However, such an arrangement is less controllable, and accordingly the present invention concentrates primarily on varying the angle of incidence for compensating the temperature-dependent variation of the filter characteristics, though the other variant previously explained is covered by the definition of the object of the invention given by the protecting claims.

This compensation, which is as complete as possible, can thus either be achieved by varying the point of impingement of the beam on the band-pass filter or by varying the angle of incidence of the beam on the band-pass filter, in each case as a function of the temperature. It is of course also possible to vary both the point of impingement and the angle of incidence as a function of the temperature, in order to achieve fullest possible temperature compensation. In general, a change in angle of incidence necessarily also causes a shift of the point of impingement of the beam on the filter. In some applications this can be accepted without any problem, but in many cases it leads to an unacceptable shift of the transmitted and/or of the reflected beam relative to subsequent coupling-out elements, so that in preferred embodiments that have yet to be explained, steps are taken to preserve the point of impingement even though the angle of incidence of the beam changes.

Beam alignment can be effected by means of a control element or actuator, which actively adapts the beam-guiding optics in relation to the temperature.

However, an embodiment of the method in which alignment takes place passively is especially preferred. “Passive” means that it does not employ active control, which adjusts the beam alignment relative to the band-pass filter according to the corresponding result of measurement of a temperature. In passive alignment, alignment takes place quasi-automatically, without requiring active control in relation to a previously detected temperature change or change in pass wavelength.

Passive alignment of this kind is carried out in a particularly preferred embodiment of the method by means of at least two elements with different coefficient of thermal expansion. It is for example possible to fit parts of the beam-guiding optics and/or the band-pass filter on both or one of each of the elements with different thermal expansion in such a way that when there is a temperature change the beam-guiding optics and the band-pass filter move relative to one another in a predetermined manner, and in particular are tilted relatively, so that the angle of incidence and/or the point of impingement of the beam change, and in such a way that this compensates, fully or at least partially, the simultaneous change in filter characteristics that is caused by the temperature change.

In a further, especially preferred embodiment of the method, it is envisaged that a deflecting element of the beam-guiding optics, e.g. a mirror or a prism, is tilted relative to the band-pass filter in relation to the temperature, so that the angle of incidence of the beam on the band-pass filter changes.

Conventionally, WDM components are constructed by multiple series connection of a basic element, which in each case filters out an individual wavelength channel and passes the remaining wavelength channels onto the next basic element. The basic elements are in each case joined together by means of a glass fibre. In particular it is also possible for a beam, of frequencies or wavelengths reflected on a filter, to be returned in an arc via a waveguide and be directed again onto the filter at a different angle, which fulfils the transmission condition for a wavelength channel still present in the beam. New optical components, e.g. multiplexers/demultiplexers, especially WDM (Wavelength Division Multiplex) components and DWDM (Dense Wavelength Division Multiplex) components, as are described in another application of the same applicant submitted at the same time with the title “Method and device for the distribution and combining of electromagnetic waves”, have a plurality of optical-interference narrow-band filters arranged in series in the direction of the beam. Variation of the angle of incidence of the beam on the first band-pass filter then generally results in variation of the point of impingement of the beam on the subsequent band-pass filters. This deviation is cumulative, so that it gets larger from one band-pass filter to another, and the impingement on the individual band-pass filters in the direction of the beam becomes increasingly off-centre. The collimation optics, generally arranged behind the band-pass filters, which serve for receiving the light channel that passes through, are adjusted to passage of the beam in the centre of the band-pass filter, therefore this leads to additional optical losses. Accordingly, for components with a very large number of channels there is in general no advantage in only changing the angle of incidence of the beam on the first band-pass filter, unless corresponding adapted filters with locus-dependent filter characteristics are used, but this means appreciable extra costs in production and adjustment of the filters.

The principles of the present invention are applicable to all three stated variants. Another especially preferred embodiment of the method envisages that the distance between two band-pass filters opposite one another and following one another in the direction of the beam is also varied as a function of the temperature. Preferably the spacing is varied essentially in the direction of the normals to the surface of the band-pass filter. By means of this displacement of the successive band-pass filters relative to one another, it is possible to compensate the shift of the point of impingement of the beam on the subsequent band-pass filters on account of the variation of the angle of incidence of the beam on the first band-pass filter. This method has the (small) advantage that the run length of the light in the component is varied.

Because the angle of incidence of the beam on the band-pass filter is varied, the angle at which the light beam, allowed through by the filter, emerges from the filter will also be varied automatically.

Therefore another especially preferred embodiment of the method envisages that the collimation optics arranged behind the band-pass filter are moved relative to the band-pass filter in relation to the temperature.

In a further, especially preferred embodiment of the method, at least one band-pass filter, preferably all band-pass filters, are tilted relative to a main body of the optical component in relation to the temperature. The angle of incidence of the beam on the band-pass filter can thus be achieved not only by altering the light beam before the first band-pass filter, but also by tilting several or all band-pass filters and/or a mirror opposite the filters, so that the angle of incidence on all band-pass filters is varied individually. Admittedly this embodiment is more complicated in its execution, but it has the advantage that the optical path length of the light in the component remains almost constant.

With respect to the optical component, the problem mentioned at the beginning is solved by an optical component with at least one band-pass filter, which displays characteristics that are dependent on the temperature of the component and/or of the band-pass filter, and beam-guiding optics, which are provided for guiding a beam through the component, and a main body, which is connected to the band-pass filter and the beam-guiding optics, and a device is provided for altering the alignment of the beam relative to the band-pass filter.

By means of this device for altering the beam alignment it is possible to vary the angle of incidence of the beam on the band-pass filter as a function of the temperature, so that the temperature-dependent variation of the characteristics of the band-pass filter can at least be reduced.

This device is preferably a passive element, requiring no active control. In an especially preferred embodiment of the present invention the passive element consists of several (i.e. at least two) actuators, which are connected to beam-guiding, reflecting or filtering elements of the optical component and have different coefficients of thermal expansion. One of the actuators can also be the housing or base of the optical component. When the temperature changes, the element connected to one or more of the said actuators moves, in particular by tilting, differently from the other elements, which are not connected to the actuators or are connected to the actuators differently.

The device can for example be designed advantageously with the beam-guiding optics having a deflecting element, which is movable, and preferably tiltable, relative to the at least one band-pass filter.

The movement or tilting of the deflecting element of the beam-guiding optics has the effect that the angle of incidence of the beam on the band-pass filter changes. Of course it is also possible to move the deflecting element in such a way that apart from a change in angle of incidence of the beam on the band-pass filter, a variation of the point of impingement of the beam on the band-pass filter either takes place in a controlled manner or is largely prevented by additional measures.

The deflecting element can for example be a component of collimator optics, which collimate the light from the glass fibre into the optical component. These collimator optics or alternatively coupling device preferably consist of a curved reflecting surface. The curved reflecting surface makes lens optics unnecessary, because the beam expansion occurring at the end of a glass fibre is at least partly compensated by the curved surface. This curved reflecting surface can assume the function of the deflecting element.

According to an especially preferred embodiment, the deflecting element and/or band-pass filter is connected to the main body via an element whose thermal expansion is different from that of the main body. As a result, when there is a temperature change the deflecting element moves relative to the band-pass filter. This embodiment is one possibility for realizing passive control of alignment variation. Advantageously, the material of the element with thermal expansion different from that of the main body is chosen in such a way or the element is arranged in such a way that a change in alignment of the beam relative to the band-pass filter occurs and the associated change in characteristics of the band-pass filter exactly compensates the temperature-dependent change of the characteristics.

When, in particular, the angle of incidence of the beam on the band-pass filter is to be varied, the deflecting element and/or the band-pass filter is connected to the main body essentially in two regions with a space between them, preferably on two opposite sides, one region being connected to the main body via an element whose thermal expansion differs from that of the main body. Because of the different thermal expansion, when the temperature of the optical component changes, this leads to tilting of the deflecting element and/or of the band-pass filter relative to the other element, so that the angle of incidence of the beam on the band-pass filter is altered.

As already mentioned, many optical components have a whole series of narrow-band filters. If, in the said components with many filters, just one optical element, e.g. the deflecting element, is altered, this has the effect that there is not only a change in the angle of incidence of the beam on the filter, but also a change in the point of impingement of the beam on the filter. The portion of the beam that does not pass through the filter is reflected at the point of impingement, so that the deviation of the point of impingement of the beam on the band-pass filter in the beam direction becomes larger from filter to filter, since the deviation is cumulative, so that impingement is increasingly off-centre on the individual filters in the beam direction. However, the collimation optics, which are generally arranged behind the band-pass filters, are adjusted to a roughly central path of the beam, so that when the point of impingement of the beam on the band-pass filter changes, this leads to additional optical losses, which become more and more serious in the beam direction. In some applications this can mean that the simple version described so far for altering the point of impingement and/or the angle of incidence is no longer sufficient on its own. Therefore, according to an especially preferred embodiment, in the case of optical components that have at least two band-pass filters, a device is provided for altering the distance between two successive band-pass filters opposite one another in the beam direction. This altering of the distance between two successive band-pass filters in the beam direction can compensate the deviation of the central point of impingement caused by the change in beam angle. Optionally, however, band-pass filters on one side can be replaced with a mirror and can otherwise be arranged next to one another. In this case, at the same time as a change in beam angle, the distance between mirror(s) and filters can also be varied appropriately, so that the points of impingement on the filters (and the mirror) nevertheless remain unchanged.

Advantageously, the device for altering the distance between two successive band-pass filters in the beam direction consists of at least one element whose expansion coefficient is different from that of the main body, via which at least two successive band-pass filters in the beam direction are connected together.

With appropriate choice of materials, it is thus possible to ensure that when the temperature changes, the successive band-pass filters positioned opposite one another and/or corresponding mirrors are moved relative to one another.

In another especially preferred embodiment it is additionally envisaged that receiving collimator optics behind a band-pass filter are also connected to the main body and a device is provided for tilting the receiving collimator optics.

Advantageously, the at least one system of receiving collimator optics is connected to a holding element, which is connected to the main body essentially in two regions that are some distance apart, preferably on two opposite sides, and one region is connected to the main body via an element whose thermal expansion is different from that of the main body.

As a result it is possible to tilt the receiving collimator optics passively as a function of the temperature, so that the collimator optics behind the band-pass filters can be compensated according to the change in angle of the light beams emerging from the band-pass filters.

Further advantages, features and possible applications will become clear from the following description of preferred embodiments and the associated diagrams, showing:

FIGS. 1a and 1b a first embodiment of an optical component for two different temperature states,

FIGS. 2a and 2b a detail enlargement of the embodiment in FIG. 1 in two temperature states,

FIG. 3 a graph showing the variation of the central wavelength as a function of the angle of incidence,

FIG. 4 a diagram showing the slope of the angular displacement as a function of the angle of incidence,

FIGS. 5a and 5b a second embodiment of an optical component according to the invention, in two temperature states,

FIGS. 6a and 6b a third embodiment of an optical component according to the invention, in two temperature states,

FIGS. 7a and 7b a perspective view of the embodiment in FIGS. 6a and 6b in two different temperature states,

FIGS. 8a and 8b a fourth embodiment of an optical component according to the invention, in two temperature states,

FIGS. 9a and 9b a detail enlargement of the embodiment in FIGS. 8a and 8b in two different temperature states,

FIGS. 10a and 10b the holder of a filter, using a solid link as the rotation axis, and

FIGS. 11a and 11b an optical multiplexer/demultiplexer with temperature compensation using appropriate solid links.

FIGS. 1a and 1b show a first embodiment of an optical component according to the invention, constructed here as multiplexer/demultiplexer. Four band-pass filters 2 are shown and one deflecting element 4, constructed here as mirrors, each of which is secured to the main body 5.

The path of the light beam within the component is shown to provide clarification, and has been given the reference 3. In the example shown, in FIGS. 1a and 1b from bottom left, information signals with four different wavelengths (λ1, λ2, λ3 and λ4) are coupled-in into the component. These signals first impinge on mirror 4 and are deflected by it onto a first band-pass filter 2. This band-pass element 2 ensures that one wavelength channel (λ1), i.e. one frequency is transmitted. All other wavelengths (λ2, λ3 and λ4) are reflected on the first band-pass filter and are directed upwards onto the second band-pass filter. On the second band-pass filter, only the wavelength channel with the wavelength λ2 can pass, whereas all other wavelengths (λ3, λ4 etc.) are reflected downwards again onto the third filter. This process now continues until the information signal, originally made up of several wavelengths, has been separated into its individual channels. The output beam reflected last may possibly still contain further channels with wavelengths that differ from the wavelengths of the coupled-out channels. This output beam can then be directed onto a further, similar component, which is able to couple-out the still remaining channels or some of them.

As already stated, the narrow-band filters are perceptibly temperature-dependent, so that typically there is a shift in central pass wavelength by 1 to 3 pm per degree kelvin of temperature change.

Especially when the individual wavelengths are very close together, so that channel separation and detection requires the use of very narrow-band interference filters, this leads to a considerable restriction of the operating temperature range. It was recognized with the present invention that the dependence of the characteristics (central pass wavelength) of the filters on the angle of incidence of the light on the filter, shown in FIG. 3, can be utilized for compensating the temperature-dependent wavelength shift of the filter. The tracking of the angle of incidence takes place passively by a suitable optical set-up, whose behaviour during temperature variation is well-defined. This well-defined behaviour can be achieved for example by using suitable materials with appropriate coefficients of thermal expansion. In the embodiment shown in FIGS. 1a and 1b, the deflecting element 4 is positioned asymmetrically, i.e. deflecting element 4 is supported on the main body 5 on the one hand, and on an element 6 on the other hand, which displays thermal expansion different from that of the material of the main body 5.

The effect achieved is shown once again, greatly exaggerated, in FIGS. 2a and 2b. FIGS. 2a and 2b each show the deflecting element 4, which is connected on the one hand directly to the main body 5 and on the other hand is connected to the main body 5 via an element 6 with different thermal expansion.

FIG. 2a shows the situation at a first temperature t₁, and FIG. 2b shows the same segment at a temperature t₂, which is lower than temperature t₁. In both cases the beam 3 that impinges on the deflecting element comes from the same direction. When the optical component is cooled, segment 6 with larger coefficient of thermal expansion contracts more than the main body 5, producing a tilting of the deflecting element 4. As is clearly shown in FIGS. 2a and 2b, this causes a corresponding change in the angle that is enclosed by the light beam 3 incident on the deflecting element 4 with the normal 8 on the reflecting surface. As a result, the light beam reflected by the deflecting element 4 at temperature t₂ is altered markedly relative to the situation at temperature t₁. The consequence of this is that, as illustrated in FIG. 1b, which also shows the situation at temperature t₂, the light beam reflected by the deflecting element 4 impinges on the first filter 2 (bottom left) at a different angle. If we further take into account that, in accordance with FIG. 3, the central pass wavelength for such a filter depends on the angle of incidence of the beam, with appropriate choice of material for element 6 we can compensate, completely or at least partially, the temperature-dependent shift of the central pass wavelength of the filters 2. This has the advantage that to achieve the same reliability and performance of a corresponding optical component, for example a demultiplexer, it is possible to use less expensive elements with larger tolerances as well as less expensive lasers as signal carriers, or alternatively, when using high-value elements, it is possible to improve the performance and reliability of the components (which can be used over a wider temperature range).

At this point it should be noted that, for greater clarity, the tilt angles are shown greatly exaggerated in the drawings. In practical application the required tilt will generally be of the order of less than 1°.

As can also be seen from FIG. 1b, the tilting of deflecting element 4 leads not only to a change in the angle of incidence of the light on the band-pass filters, but in addition there is displacement of the point of impingement of the beam on the band-pass filter. Owing to the modified angle, such displacement of the point of impingement now also takes place from filter to filter, so that the deviations become larger and larger. As can also be seen from FIG. 1b, the deviation of the point of impingement of beam 3 relative to the original point of impingement, indicated by the dashed beam path 3′, already has double the displacement at the second filter compared with the first filter. The deviation therefore increases from filter to filter, so that the impingement of the light on the filters is increasingly off-centre.

Suitable collimation optics or electro-optical converters, which either process the coupled-out channels directly or pass them on appropriately, are generally arranged behind the filters (not shown). These optics or information-processing systems are generally designed and appropriately adjusted for a roughly central beam path. Therefore if, with increasing number of filters, the displacement of the point of impingement on the filter becomes too large, this leads to additional, and in some circumstances unacceptable, optical losses. For components with a large number of channels this can have the effect that the simple embodiment shown is less suitable.

For clarification of the effect on which the invention is based, FIG. 3 shows an x/y diagram, in which the relative shift of the central pass wavelength (ordinate) is plotted against the angle of incidence (abscissa).

In addition, in FIG. 4 the slope of the angle characteristic line (derivative of the function shown in FIG. 3) is plotted against the angle of incidence.

FIGS. 5a and 5b show a second embodiment of the optical component according to the invention.

The construction largely corresponds to the construction shown in FIGS. 1a and 1b. Additionally, the two elements 7, which have a suitably selected thermal expansion, have been added. As a result, when the component is cooled, not only is deflecting element 4 tilted, on account of element 6, which moves in the direction of the arrow, but also the band-pass filters, arranged at the bottom in the diagrams, are moved towards or away from this on account of the contraction or expansion of elements 7 in the direction of the two arrows towards the band-pass filters arranged above. In other words the spacing of the two filters is also altered as a function of the temperature, so that the point of impingement of the light beam on the filter remains at roughly the same place. This embodiment can thus also be used without restriction for components with a very large number of channels.

This embodiment only has the slight disadvantage that the optical path length varies within the component, so that slight variations in insertion loss may occur as a function of temperature. Owing to the change in angle of an incident and transmitted beam, during passage into the subsequent output optics there may also be losses in signal amplitude in the embodiments described so far, but these can be avoided if the output optics are also readjusted automatically with the same means as the beam-guiding, filtering and reflecting elements, as will be explained below.

The tilting of the deflecting element or of mirror 4 in the two embodiments shown in FIGS. 1a and 1b and 5a and 5b leads, at all outputs (λ1, λ2, λ3 and λ4), to an angle error relative to the original beam. In other words, the deflecting element alters not only the angle of incidence of the light beam on the filter, but also the angle that the transmitted light beam encloses with the normal on the filter surface. Therefore, ideally, the collimation optics that are arranged behind the filters for receiving the transmitted beams, should also be tracked as a function of the temperature, so that the transmitted beams impinge on the collimation optics in optimum alignment as far as possible.

FIGS. 6a and 6b show a third embodiment of an optical component with temperature compensation according to the invention. Here the collimation optics of the outputs are made integral with the main body 5. For example, deflecting element 4 is constructed here as a curved reflecting surface 13, which serves at the same time for parallelization of the light beam emerging directly from the glass fibre.

Collimation optics 9 are arranged behind each individual band-pass filter (λ1, λ2, λ3 and λ4), and also consist of a curved reflecting surface, and collimate the parallel light beam for example into the core of subsequently arranged glass fibres 12. The individual band-pass filters 2 are in this case all arranged in a row. A mirror 11 is arranged opposite the band-pass filters 2, in a plane arranged under them. If we follow beam path 3, it becomes clear that the light beam is first deflected via deflecting element 13 onto the first band-pass filter 2, which only allows wavelength channel λ1 to pass, whereas all other wavelengths are reflected onto mirror 11. The remaining information signals are then deflected by mirror 11 onto the second band-pass filter 2, which only allows the wavelength channel with wavelength λ2 to pass, whereas all other wavelengths are again deflected onto mirror 11. This sequence continues until the original information signal has been split into its individual channels. The change of the angle of incidence of the light beam on band-pass filter 2 according to the invention is effected by element 6, which possesses thermal expansion different from that of the material of the main body 5. When the temperature rises, this leads to tilting of the lower plane of main body 5, as shown in FIG. 6b.

However, to maintain a fixed point of impingement of the light beam on the band-pass filters, just as in the second embodiment in FIGS. 5a and 5b, elements 7 are provided which, owing to their corresponding thermal expansion, move the plane of the filter and the plane of mirror 11 relative to one another. The change in angle of the transmitted beams is in this case compensated by means of element 10, which also displays thermal expansion that is different from the thermal expansion of the material of main body 5. As will be clear on comparing FIGS. 6a and 6b, element 10 ensures that the upper plane of main body 5 is tilted, so that the transmitted light beams again impinge on the collimation optics 9 at roughly the same angle as was the case at temperature t₁ (see FIG. 6a).

FIGS. 7a and 7b show a perspective view of the embodiment of the optical component of FIGS. 6a and 6b. The glass fibres 12 and the curved reflecting surfaces 9, forming the collimation optics, can be clearly seen. The main body 5 is made from several mouldings, which are joined together via elements with different thermal expansion. The filter plane 2 and the mirror plane 11 always remain parallel to one another. The symmetrical arrangement of the expansion elements 7 merely has the result that the two parallel planes move towards or away from one another. Expansion element 6, which connects the top part of main body 5 asymmetrically to mirror plane 11, ensures that deflecting element 13 (not shown in FIGS. 7a and 7b), which is connected rigidly to the top part of main body 5, is tilted, so that when there is a change of temperature of the optical component, the angle of incidence of the light beam on filters 2 changes. Expansion element 10 is provided for tracking the collimation optics, which are connected to the bottom part of the main body 5, and the said expansion element 10 produces asymmetric movement, i.e. tilting, of the bottom part of main body 5 relative to the filter plane 2. The temperature-dependent variation of the central pass wavelength of band-pass filters 2 can be fully compensated by appropriate choice of the materials for the expansion elements 6, 7 and 10.

Finally, FIGS. 8a and 8b show a fourth embodiment of the present invention. Here the individual band-pass filters 2 have tiltable mounting, but the deflecting element 4 does not. The asymmetric mounting of the band-pass filters 2 is shown on an enlarged scale in FIGS. 9a and 9b. Just as in the case of asymmetric mounting of the deflecting element 4, as shown in FIGS. 2a and 2b, on one side filter 2 is supported directly on main body 5 and on the other side it is supported on an expansion element 14, which is in its turn supported on main body 5. Owing to the different thermal expansion of thermal expansion element 14 relative to the main body 5, a temperature change leads to tilting of filter element 2 relative to the main body 5. It can be clearly seen in the diagrams that this also has the effect that there is a corresponding change in the angle of incidence of the light beam on filter element 2. In addition, we can also see the expansion elements 7, which ensure that when the temperature changes, the lower filter plane moves towards or away from the upper filter plane, and expansion elements 15, which are arranged in such a way that when there is a change in temperature, the upper filter plane is displaced sideways relative to the lower filter plane. This embodiment has the advantage that overall, relative to the third embodiment, a shorter optical path is required in the optical component. In the case of the embodiment shown in FIGS. 6 and 7, in fact, the optical path length of the light in the optical component is increased markedly by the mirror. However, to cover this longer path there must be greater divergence of the light beam, which requires greater precision of angular accuracy. Another advantage of the embodiment according to FIGS. 8 and 9 is that the angle of incidence of the outgoing beams (after passing through the filters) is not affected by the tilting of the filters, and thus always remains the same, and there is only a slight lateral displacement.

For the reflected beam, however, tilting of the filter by an angle α means a deviation by an angle 2α relative to the previous direction, and this is compensated in its turn by the tilting of an opposite reflector by the angle α, so that the reflected beam again travels in the same direction as the original beam, even if with a slight lateral displacement.

As can be seen in particular from the perspective representation in FIGS. 7a and 7b, the optical components of the present invention generally consist of injection mouldings, which are essentially dimensionally stable. Advantageously, these mouldings are glued to spacing elements arranged partly between the mouldings, and the spacing elements 6, 7 and 10 have a deliberately chosen thermal expansion that differs from the thermal expansion of the other mouldings. The optical elements, i.e. the optical fibres, collimators, mirrors and filters are arranged and/or secured on the injection mouldings in the conventional manner. The gluing, preferably using a permanently elastic adhesive, endows the joint between the mouldings of main body 5 and the spacing elements 6, 7 and 10 with certain properties of articulation, and it is entirely sufficient, according to the present invention, if these glued joints permit very slight relative tilting between the individual housing elements, of the order of 1° or less.

Provided the same spacing elements are arranged on both sides of a housing, such as element 7 shown in FIG. 7, then this element 7 only produces a change in distance between the mouldings that are connected to it, without relative tilting. In contrast, the spacing elements 6 and 10 are only provided on one side, whereas equalizing elements can in each case be provided on the opposite side (not shown here), consisting of the same material as the other mouldings of the main body 5. Depending on the arrangement and the particular application, the spacing elements 6, 7 and 10 can have either higher or lower thermal expansion than the mouldings of main body 5, and it is also possible to choose elements with negative thermal expansion. In any case, the elements are always arranged in such a way that as the temperature rises the angle of incidence increases, so as to shift the pass wavelength towards smaller wavelengths, because at the same time, because of the temperature rise of the interference layer its intrinsic pass wavelength becomes greater, so that the two opposing effects are largely or completely compensated and the pass wavelength becomes temperature-dependent in consequence.

As already mentioned, in all the drawings and especially in FIG. 7b, the relative tilts of the individual components are shown greatly exaggerated, in order to make it easier to understand the principle of the present invention.

With the invention described, the effect of the dependence of the pass wavelength in narrow-band filters on the angle of incidence is cleverly utilized for compensating the temperature-dependent shift of the pass wavelength of the filters. Tracking of the angle of incidence takes place passively by a suitable optical set-up, which displays well-defined behaviour during temperature variation. As a result, optical components are achieved that have a more stable pass band over a wider temperature range. Therefore operation of the components is possible over a much wider temperature range. The component can thus be specified with a broader pass band, so that for example a cheaper laser with poorer specification can be used.

FIGS. 10a and 10b show an optical filter 2, which is mounted on a base or a housing 5, and filter 2 is fixed to a segment of housing 5, which is connected to the rest of the housing via a weak point of the housing material, which acts as a hinge. On the other side, filter 2 is mounted indirectly on an actuator 4, whose coefficient of thermal expansion is different from that of the material of housing 5. FIGS. 10a and 10b show the same structural element at different temperatures, it being assumed that actuator 4 displays much greater thermal expansion than the material of housing 5, which is rather represented as essentially unchanged in its dimensions. On the basis of the arrangement according to FIG. 10a, a drop in temperature causes a marked contraction of the actuator 4 according to FIG. 10b. Because actuator 4 is connected rigidly to one end of filter 2, this is lowered and, via the rigid connection of filter 2 to the opposite part of housing 5, this bends at the solid hinge 17.

A concrete application of these solid hinges can be seen from FIGS. 11a and 11b. In the case of FIGS. 11a and 11b, the central element 5 is to be regarded as a rigid, fixed housing, on which several filters 2 of the arrangement shown are mounted, in order to couple-out wavelengths λ1, λ2, λ3 and λ4 at a first temperature according to FIG. 11a. The respective coupled-out beams as well as the reflected output beam are collimated via collimators 13′ or 13″ towards further optical fibres or other optical components. Collimators 13, 13′ and 13″ are each mounted rigidly on respective housing elements 25, 26 and 27, and these housing elements 25, 26 and 27 are each connected via solid hinges 17, 18, 19 at one end to the main housing 5, whereas in its turn the other end is mounted via actuators 4 on main housing 5. Because the thermal expansion of the actuators 4 again differs markedly from the material of housing 5, on comparing with FIG. 11b it can be seen that the ends of the corresponding housing segments 25, 26, 27 are moved or oscillated relative to the main housing 5, with the solid hinges 17, 18, 19 serving as hinges. Comparison between FIGS. 11a and 11b shows that, among other things, the collimator 13 secured to housing element 25 is rotated about hinge 17, with the result that the angle of the input beam emerging from collimator 13 changes, and concretely it becomes smaller on transition from FIGS. 11a to 11b. This means that the beam reflected on the first filter 2 is also reflected at a smaller angle and also impinges on the next filter at a smaller angle, and so on. At the same time, on the output side of the filters, collimators 13′ or 13″ tilt about their respective solid hinges 19 and 18 respectively, the change in angle of the output beams is compensated, so that collimators 13′ and/or 13″ still focus the respective output beam onto the successive optical components, without the need for any other correction in the adjustment.

### List of Reference Numbers

(1) optical component
(2) band-pass filter
(3) beam
(4) deflecting element
(5) main body
(6), (7) expansion elements
(8) normal
(9) collimation optics
(10) expansion element
(11) mirror
(12) glass fibres
(13) collimator optics
(14), (15) expansion elements

### Figure Captions

FIG. 10a temperature t₁

FIG. 10b temperature t₂

FIG. 11a temperature t₁ angle of incidence on filter: α1

FIG. 11b temperature t₂<t angle of incidence on filter: α2

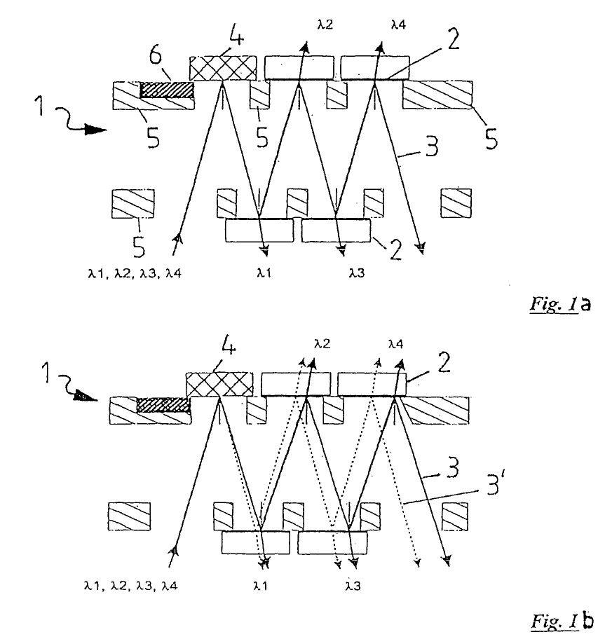

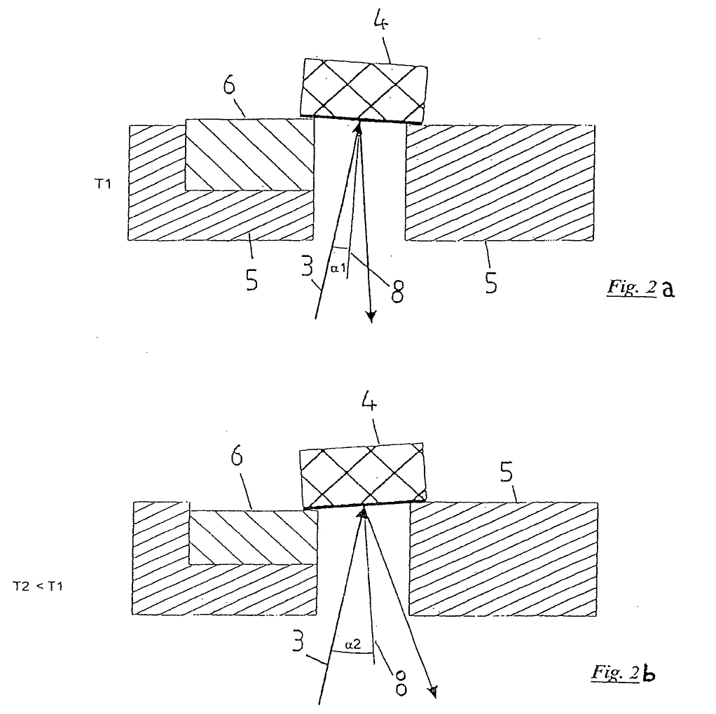

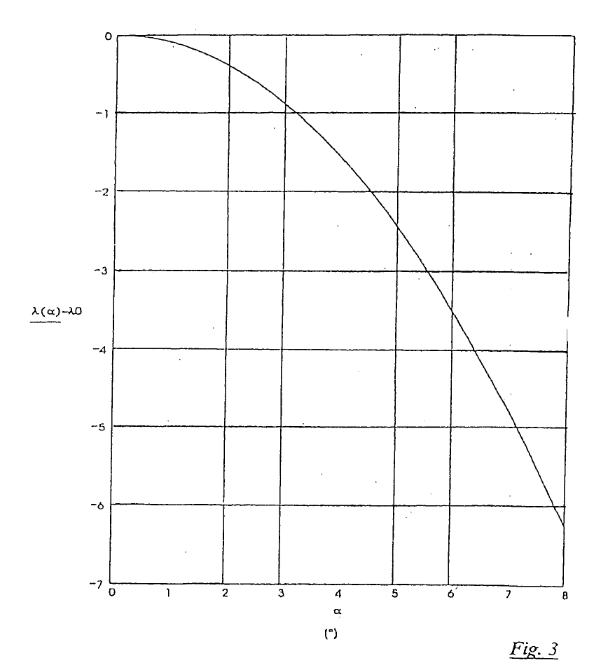

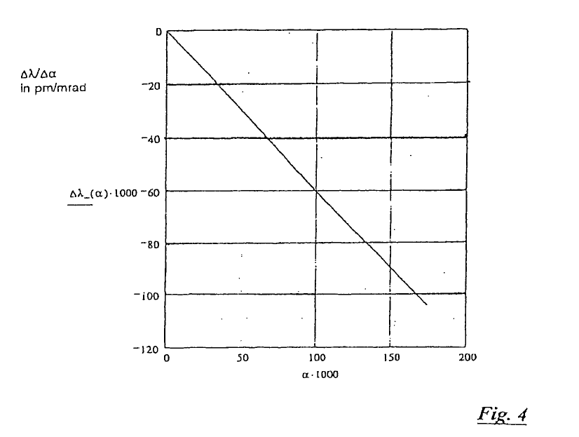

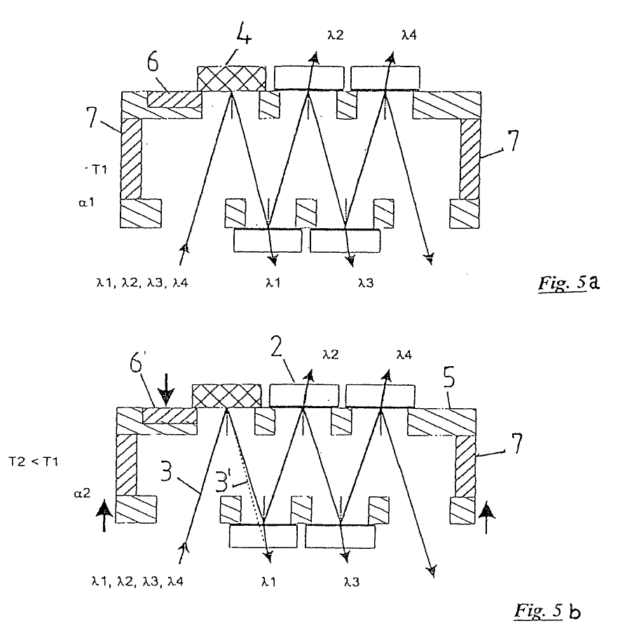

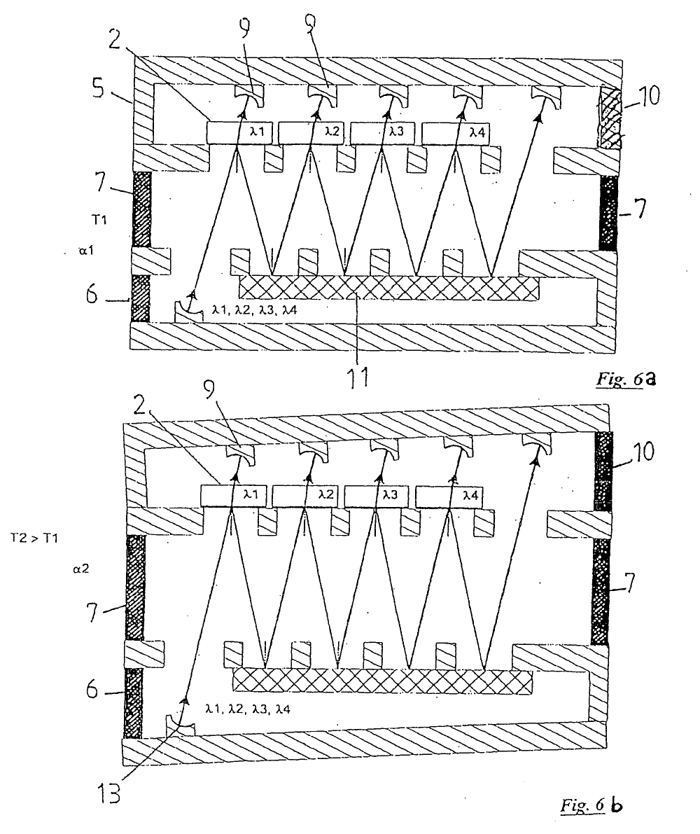

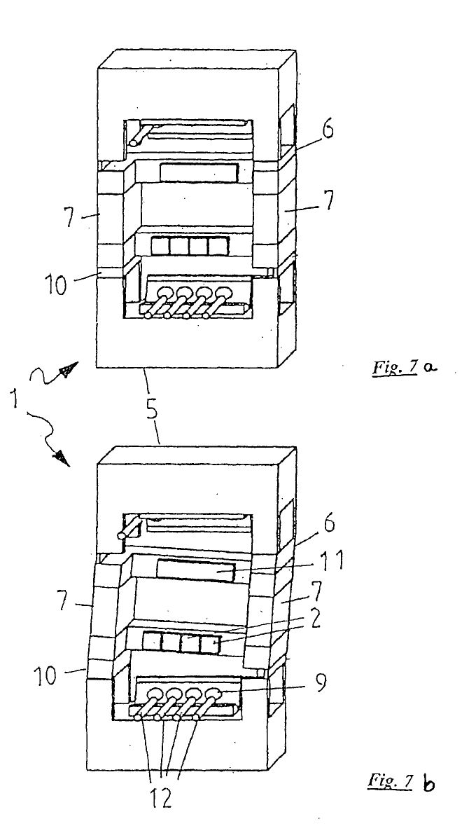

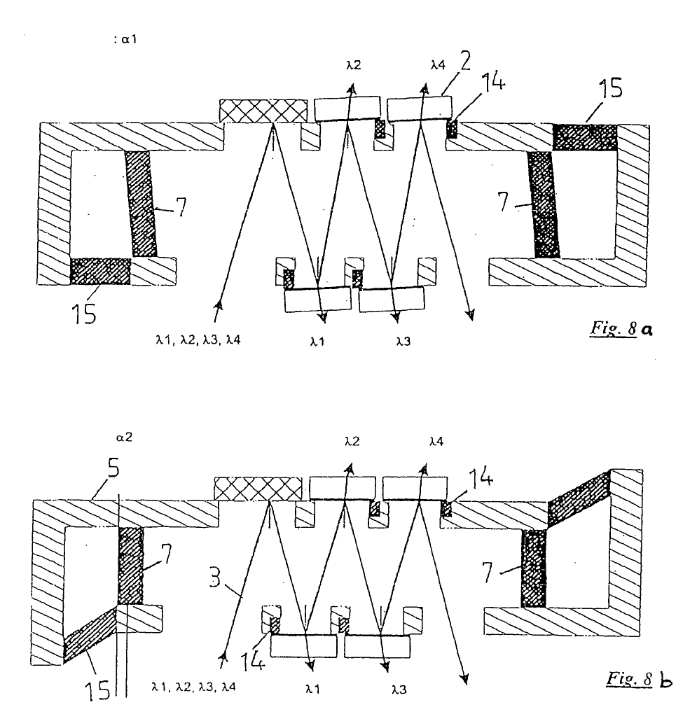

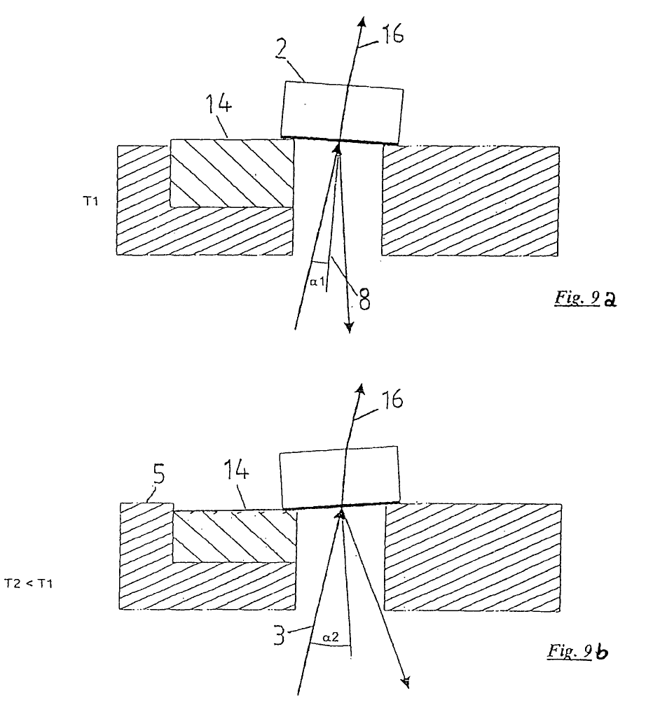

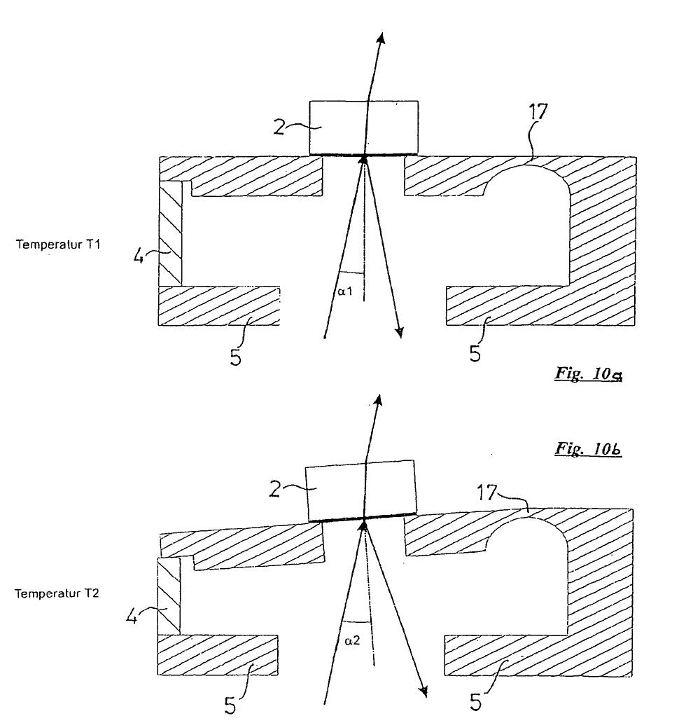

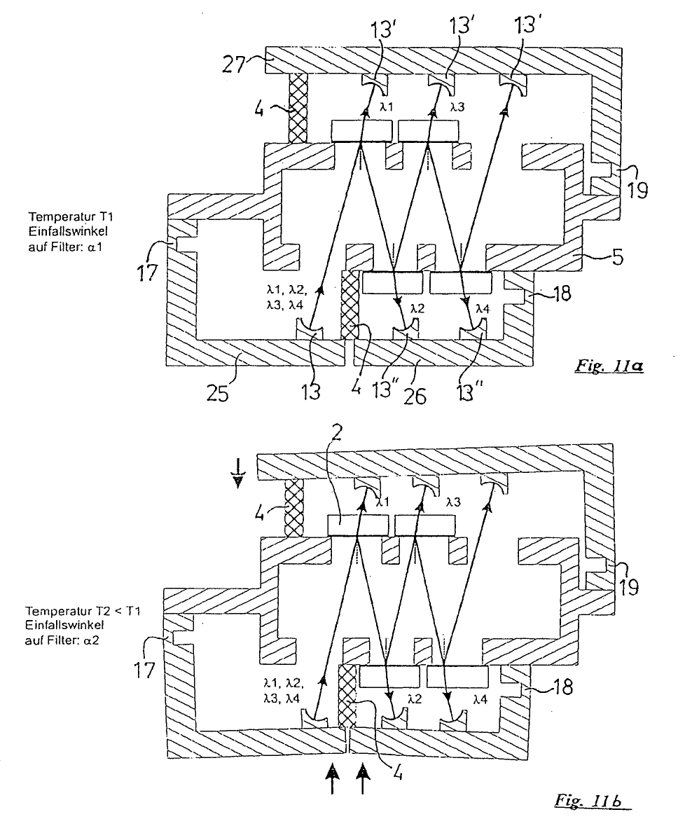

1. A method for temperature compensation of an optical component with at least one cut-off or band-pass filter and beam-guiding optics by the steps which comprise aligning a beam relative to the cut-off or band-pass filter the, orientation of said beam modified according to the temperature of the optical component.

2. The method according to claim 1, wherein the alignment of said beam relative to said band pass filter is varied so that the temperature-dependent shift of the band pass is at least partially compensated.

3. The method according to claim 1, wherein the point of impingement of said beam on said band-pass filter is varied as a function of the temperature.

4. The method according to claim 1, wherein the angle of incidence of said beam on said band-pass filter is varied as a function of the temperature.

5. The method according to claim 1, wherein the step of aligning the beam relative to the band-pass filter takes place passively.

6. The method according to claim 1, wherein alignment of the beam is effected by means of at least two elements with different coefficients of thermal expansion.

7. The method according to claim 1, wherein a deflecting element of a beam-guiding optics is tilted relative to the at least one band-pass filter.

8. The method according to claim 1, wherein the spacing of two successive band-pass filters in the direction of the beam is varied as a function of the temperature.

9. The method according to claim 6, wherein at least one system of collimation optics arranged behind said band-pass filter is moved relative to the band-pass filter as a function of the temperature.

10. The method according to claim 6, wherein said at least one band-pass filter is tilted relative to a main body of the optical component as a function of the temperature.

11. An optical component for altering the alignment of a beam relative to a filter comprising at least one cut-off or band-pass filter that dependent on the temperature of said component or of said filter and a beam-guiding optics for guiding a beam through said component, and with a main body, connected to said filter and the beam-guiding optics.

12. The optical component according to claim 11, including means for varying the point of impingement of the beam on said band-pass filter.

13. The optical component according to claim 11 including means for varying the angle of incidence of said beam on said band-pass filters.

14. The optical component according to claim 11, wherein said component is passive.

15. The optical component according to claim 11, including a movable deflecting element, which can be moved, relative to the at least one band-pass filter.

16. The optical component according to claim 15, wherein the deflecting element is part of a system of collimator optics.

17. The optical component according to claim 15, wherein said deflecting element and/or band-pass filter (is connected to the main body via means for displaying differences in thermal expansion different from the main body.

18. The optical component according to claim 17, wherein said deflecting element and/or the band-pass filter is connected to the main body in multiple spaced regions.

19. The optical component according to claim 11, including at least two band-pass filters and for varying the spacing of two successive band-pass filters in the direction of the beam.

20. The optical component according to claim 19, wherein said means for varying the spacing of two successive band-pass filters in the direction of the beam comprises at least one element with a coefficient of expansion different from that of the main body, and at least two successive band-pass filters in the direction of the beam are connected to one another.

21. The optical component according to claim 11, further comprising at least one system for receiving collimator optics 9 and means for tilting the receiving collimator optics.

22. The optical component according to claim 21, wherein said at least one system for receiving collimator optics is connected to a holding means for connecting to the main body multiple spaced regions.

23. The optical component according to claim 11 wherein the optical component is a wavelength division multiplexing component.
